(19) United States
(12) Patent Application Publication
(10) Pub. No.: US 2006/0236952 A1
(43) Pub. Date: Oct. 26, 2006

(54) PORTABLE ANIMAL PLAYPEN

(76) Inventor: Lise King, Port Washington, NY (US)

Correspondence Address: WILLIAM COLLARD;COLLARD & ROE, P.C., 1077 NORTHERN BOULEVARD, ROSLYN, NY, 11576, US

(21) Appl. No.: 10/907,944

(22) Filed: Apr. 21, 2005

(51) Int. Cl. A01K 1/03

(52) U.S. Cl. 119/499

(57) ABSTRACT

A portable animal playpen or containing device for containing animals in an enclosure comprising a mat, a plurality of substantially vertical support members coupled to the mat and a roof coupled to the substantially vertical support members. There can also be a plurality of support bars coupled at each ends to the frame. There can also be a hinge for rotationally coupling the plurality of support bars to the substantially vertical support members on the frame. This device is designed so that it is functional and portable for all users.

### BACKGROUND OF THE INVENTION

### Field of the Invention

The invention relates to a portable animal playpen or containing element that can be used to contain dogs, cats or other pets. In this case, this containing element or device can be in the form of a tent.

### SUMMARY OF THE INVENTION

A portable animal playpen or containing device for containing animals in an enclosure comprising a base in the form of a mat, a plurality of support members in the form of a frame coupled to the mat, and a roof coupled to the support members. In use, these support members can extend substantially vertically. There can also be a plurality of support bars coupled at a first end to the vertical support members and at an opposite end the substantially vertical support members. There can also be a hinge for rotationally coupling the support bars to the substantially vertical support members.

In one embodiment, the roof further comprises support members or bars extending up to a central point. This device can also include a netting coupled to the frame. There can also be a door formed from a zipper coupled to this netting or mesh material, wherein this door is made from the netting or mesh material as well, and is opened via unzipping this netting. This device can also comprise an additional set of support bars, wherein these support bars extend substantially horizontally when in use and are for spacing the vertically extending support members apart from each other.

There can also be a plurality of stakes coupled to the base mat or bracket, wherein the plurality of stakes are used to secure the mat into a secured position. This base mat can be hexagonal, octagonal or substantially circular shaped.

In this case, the roof structure can be formed as a section coupled to the frame in the in the form of a plurality of support members coupled to the vertically extending support members, wherein this roof further comprises a substantially waterproof awning or cover. In this case, each of these plurality of roof support bars or members are coupled to at least one corresponding substantially vertically extending support member to form the frame.

This entire device then allows a user to set up an enclosure for a pet which can for example be a dog or a cat which forms an entire enclosure around an animal while still providing a mesh opening to allow air to permeate the enclosure while the roof provides both water and sun protection for a dog, a cat or any other animal.

One of the benefits of this device is that it allows a user to put an animal such as dog into a self-contained closure while still being able to view that dog.

Another benefit of this invention is that all of the parts may come in individual portable form and then assembled to form a final product.

Another benefit is that all of the parts of this design may be stored in a carrying bag for easy transport of the device.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a perspective view of one embodiment of the device;

FIG. 2 is a perspective view of a second stage of assembly of the device;

FIG. 3A is a perspective view of another stage in assembly of the device;

FIG. 3B is a perspective view of another stage in the assembly of the device;

FIG. 3C is a perspective view of an additional stage in the assembly of the device;

FIG. 3D is a close up view of a connection element between a spacing or spreader bar;

FIG. 3E is a close up view of a connection between a bracket and a frame and a mat;

FIG. 3F is a close up view of a connection element of a spacing or spreader bar;

FIG. 3G is a perspective view of a top section of a frame;

FIG. 4A is an exploded perspective view of the assembly of the frame;

FIG. 4B shows an assembly of a frame to a hub;

FIG. 4C shows an assembly of a netting or mesh material to the frame;

FIG. 4D shows an assembly of a top portion of the netting or mesh material to the frame;

FIG. 4E shows an assembly of a bottom portion of the netting to the frame;

FIG. 5 shows an exploded view of the device; and

FIG. 6 is a semi-exploded view showing the cover being put on the device.

### DETAILED DESCRIPTION OF PREFERRED EMBODIMENTS

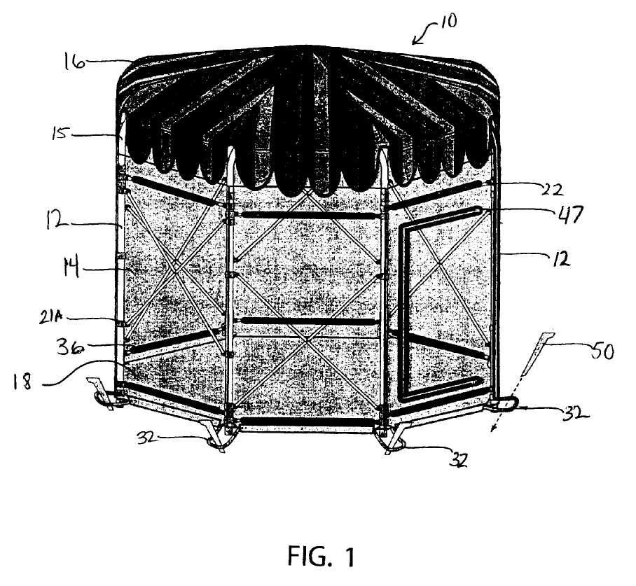

Turning now in detail to the drawings, FIG. 1 shows a perspective view of a device 10 which can function as a playpen for animals.

This device can include a frame, which is formed from a plurality of bars forming a frame 12, and a mesh netting extending around and coupled to frame 12. There can also be a cover or a top awning 16 which can be made from a fabric, which can be place on top of frame 12. Frame 12 can also include angled bars 15 forming a roof, which extends up from a base section of frame 12 and are used to support cover 16. A mat 18 can be spread out over a bottom section on the ground wherein this mat can contain a plurality of sections and be formed from a PVC mesh material or any other suitable material may be used as well.

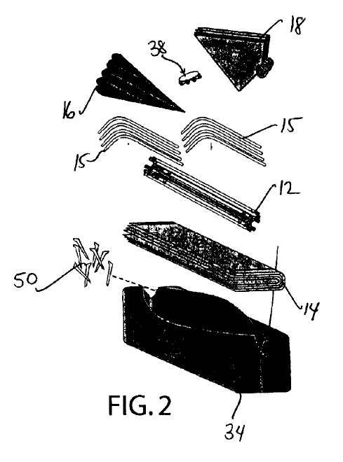

As shown in FIG. 2 the device can be formed as a kit, which can be fit inside of a bag 34. The kit includes all of the above-identified parts as well as a hub 38 and stakes 50, which can be removed from bag 34 and then assembled.

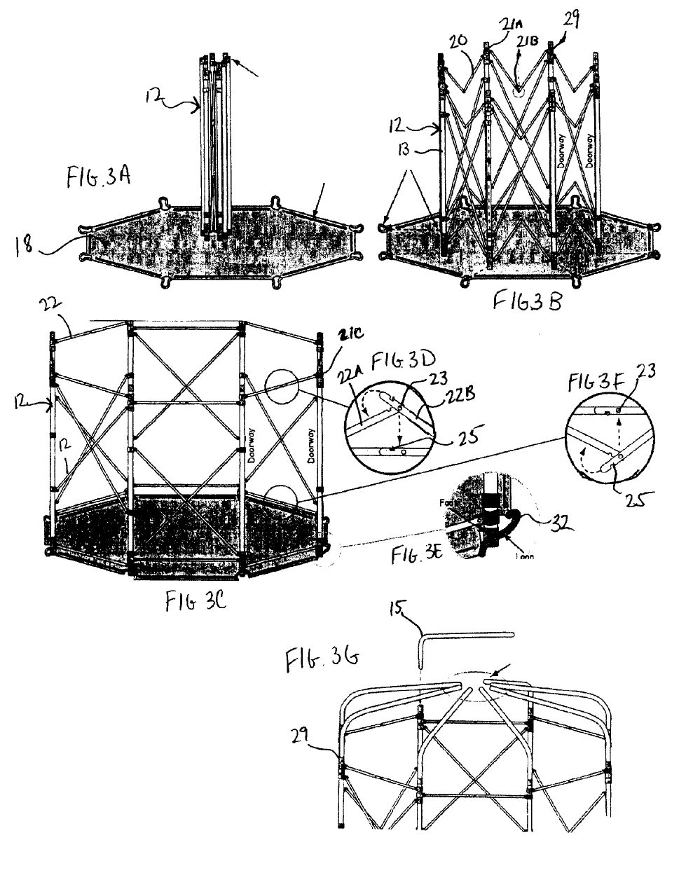

FIGS. 3A-3G show the various stages of assembly of frame 12. In this case, frame 12 can be placed above mat 18 as shown in FIG. 3A and then radially expanded outward as shown in FIG. 3B. For example, coupled to frame 12 can be a plurality of substantially angled stabilizing connecting bars 20, which can be used to connect frame 12 together.

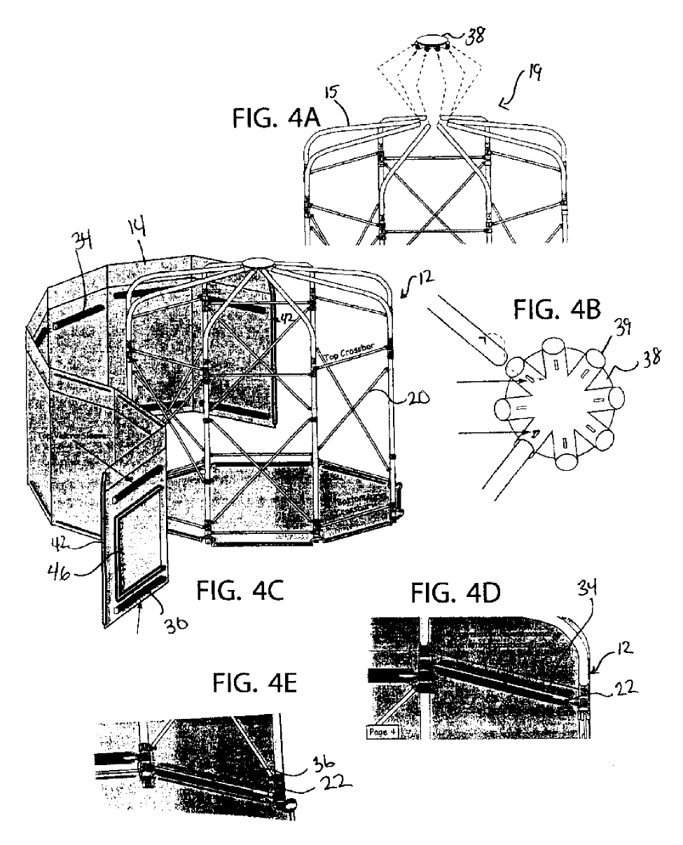

There are also a plurality of spreader bars 22 which can be used to keep the frame elements 12 spread apart from each other. Stabilizing connecting bars 20 can be connected to frame 12 via a bracket 24 having a hinge, such that frame 12 can be formed as a single interconnected frame that can be radially expanded outward such as shown in FIGS. 3A, 3B, and 3C. In addition spreader bars 22 can be connected to frame 12 via a hinge bracket 21c as well. Spreader bars 22 can be fastened to the netting as shown in FIGS. 4E and 4D.

For assembly, these substantially vertically extending members are pulled apart while connecting bars 20 expand out via hinges 21a and 21b to allow the frame to expand radially out. FIG. 3C shows the fully expanded frame, which can then be inserted into and placed into ground stake loops 32 in mat 18 as shown in FIG. 3E. FIG. 3D shows the two different stages of assembling spreader bars 22 which can be formed as two different bars 22a and 22b having a hinge 23 coupling the two bars 22a and 22b together. In addition, there is a latch 25 which can be used to lock spreader bars 22 in place once these two bars 22a and 22b have been extended out to their fullest extent. Thus, in this first stage, the two different bars 22a and 22b can be in a bent or broken form wherein these two bars can then be rotated relative to each other via hinge 23 to couple these two bars together so that they latch via latch 25 in a second position. FIG. 3F shows this process via the lower spreader cross bars 22 as well.

FIG. 3G shows the insertion of the curved bars 15 associated with frame 12. In this case, curved bars 15 can be in the form of bent aluminum poles, which can be inserted into brackets 29 on frame 12. These curved bent poles radiate inwards towards a center region wherein these poles are then covered by a cover.

FIG. 4A shows a perspective view of an assembly of these curved poles wherein this assembly can include a central hub 38, which has a plurality of slots 39 radiating in an outward direction. These slots 39 are to receive end portions of these curved poles as shown in FIG. 4B to form a roof 19.

FIG. 4C shows mesh netting 14 being attached to frame 12. In this case, mesh netting can include wraps 34 and 36 with wraps 34 being top wraps, and wraps 36 being bottom wraps. Top wraps 34 attach to top cross bars or spreader bars 22, while bottom wraps 36 attach to bottom cross bars or spreader bars 22. Wraps 34 and 36 can be secured over cross bars 22 via a fastener which can be any suitable fastener known in the art but can for example be a hook and loop fastening strip for wrapping around these cross bars 22 as shown in FIGS. 4D and 4E. FIG. 4C also shows a door 46 which can be made integral with mesh netting 14 wherein this door can be opened via a zipper 47.

This mesh netting 14 can be secured around the device wherein once mesh netting 14 is wrapped around frame 12, a zipper 42 can be zipped up along the two peripheral ends to enclose mesh netting 14 around frame 12.

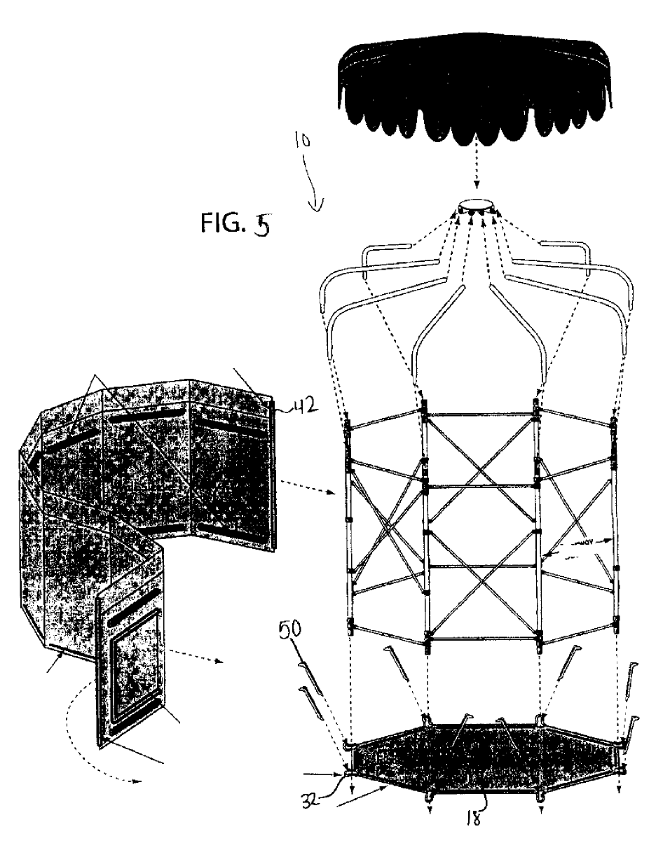

FIG. 5 shows an exploded view of the full assembly of the device 10 including ground stakes 50 wherein these ground stakes 50 can be used to secure mat 18 to a ground surface through loops 32.

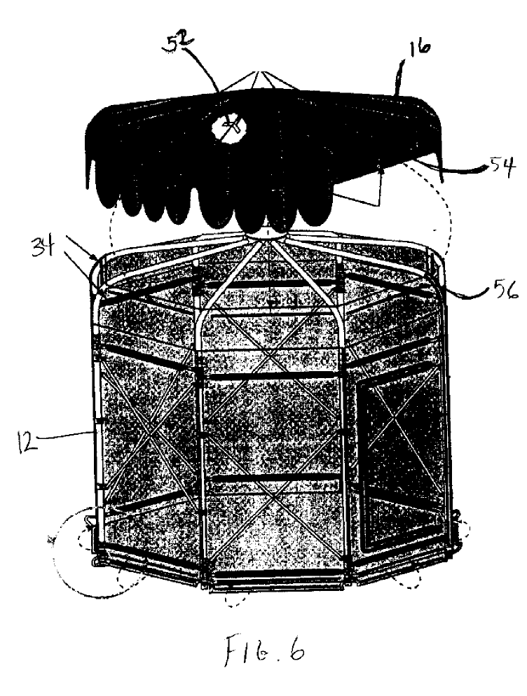

FIG. 6 shows the fastening process for applying cover top 16 to frame 12 and mesh netting 14. In this case, cover top 16 includes a plurality of fasteners for securing the cover top 16 to the rest of the device. A first set of fasteners 52 can be in the form of a hook and loop fastener, which can be used to secure cover top 16 to frame 14 by wrapping around bent bars 15. In addition, an additional fastener 54 can be used to fasten to fasteners 56 on mesh netting 14. This additional fastener 54 can be in the form of a fastening strip such as a hook and loop fastener, which can then be fastened to a complementary fastener 56. Additional types of fasteners may be used, for example, straps, clamps, ties, etc.

This device can be disassembled as well using similar methods described for its assembly. In addition, this device presents itself as a self-contained kit, which can be opened and expanded to house a pet.

Accordingly, while a few embodiments of the present invention have been shown and described, it is to be understood that many changes and modifications may be made thereunto without departing from the spirit and scope of the invention as defined in the appended claims.

What is claimed is:

1. A containing device for containing animals in an enclosure comprising:
a) a base mat;
b) a frame;
c) a roof coupled to said plurality of substantially vertical support members;
wherein when the device is assembled, said frame comprises a plurality of support bars coupled at a first end to said base and at an opposite end to at least one of said plurality of substantially vertical support members; and
e) a hinge for rotationally coupling said plurality of support bars to said substantially vertical support members.

2. The device as in claim 1, wherein said roof further comprises a plurality of support members extending up to a central point.

3. The device as in claim 1, further comprising a mesh netting coupled to said frame.

4. The device as in claim 3, further comprising a door formed integral with said netting and a zipper, coupled to said netting, wherein said door is made from said netting as well and is opened via unzipping said zipper in said netting.

5. The device as in claim 1, further comprising an a plurality of spreader bars, coupled to said frame, wherein said spreader bars are in the form of substantially horizontally extending support bars for spacing said substantially vertically extending support members apart from each other.

6. The device as in claim 1, further comprising a plurality of stakes, wherein said plurality of stakes are used to secure said mat in a secured position.

7. The device as in claim 1, wherein said mat is octagonal shaped.

8. The device as in claim 1, wherein said roof is in the form of a plurality of support members coupled to said substantially vertically extending support members, wherein said roof further comprises a substantially waterproof cover.

9. The device as in claim 8 wherein said substantially waterproof cover is secured to said plurality of support members via a hook and loop fastener.

10. The device as in claim 9, wherein each of said plurality of roof support members are coupled to said at least one corresponding substantially vertically extending support member.

11. The device as in claim 1, wherein said mat has a non-circular shape.

12. A portable kit for forming an animal playpen comprising:
a) a collapsible mat;
b) a frame formed from a plurality of substantially vertical support members which can be coupled to said collapsible base;
c) a roof which can be coupled to said plurality of substantially vertical support members;
d) a plurality of support bars which can be coupled at a first end to said base and at an opposite end to at least one of said plurality of substantially vertical support members; and
e) a hinge for rotationally coupling said plurality of support bars to said substantially vertical support members.

13. A containing device for containing animals in an enclosure comprising:
a) a mat;
b) a plurality of substantially vertical support members coupled to said mat;
c) a roof coupled to said plurality of substantially vertical support members;
d) a plurality of support bars at a first end to said base and at an opposite end to at least one of said plurality of substantially vertical support members; and
e) a hinge for rotationally coupling said plurality of support bars to said substantially vertical support members.

14. The device as in claim 13, further comprising a mesh coupled to said plurality of substantially vertical support members.

15. The device as in claim 13, further comprising a door, wherein said door comprises a first zipper element coupled to said mesh, a door part made from said mesh, and a second zipper element coupled to said door part.

16. The device as in claim 13, wherein said roof further comprises a solid cloth covering.

17. The device as in claim 13, further comprising a bracket coupled to a top end of said substantially vertically extending support members wherein said roof is coupled to said bracket.

18. The device as in claim 17, wherein said bracket comprises a plurality of different elements, and wherein the device further comprising a connection joint coupled to at least one of said substantially vertically extending support members and to at least one of said bracket elements.

19. The device as in claim 18, wherein said connection joint comprises at least one hinge.
